(19) United States
(12) Patent Application Publication
(10) Pub. No.: US 2005/0177571 A1
(43) Pub. Date: Aug. 11, 2005

(54) Systems, methods, and computer-readable mediums for accessing local and remote files

(76) Inventor: Aland B. Adams, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/775,445

(22) Filed: Feb. 9, 2004

(51) Int. Cl. G06F 17/30

(52) U.S. Cl. 707/10

(57) ABSTRACT

Systems, methods, and computer-readable mediums for accessing remote files are disclosed. In one embodiment, a driver is used to filter read requests initiated by a client computer. If a file that is the subject of a read request is referenced by a local file system of the client computer, the driver routes the read request to the local file system. If a file that is the subject of a read request is not referenced by the local file system, the driver routes the read request to a remote file system. All requests to write files of the remote file system are routed to the local file system, thereby causing a file that is the subject of such a request to be written to the local file system.

### BACKGROUND OF THE INVENTION

The management of multiple-client systems can be simplified if the systems are kept in a consistent state. One method for doing this is to store master files (e.g., operating system and application files) on one machine and share these files with all of the clients in the system. File-sharing systems operating in accordance with this method generally fall into two categories.

In the first category, files may be read and written by all systems sharing the files. Examples of these types of systems include Single System Image (SSI) and cluster-wide file systems. Because all clients share the same file image, clients cannot customize files for their particular needs. Also, corruption of a file by one client corrupts the file for all other clients.

In the second category, a remote system tracks, and separately stores, changes that individual systems make to remotely shared files. One example of this type of file system is Hewlett-Packard Company's context dependent file system (CDFS).

### SUMMARY OF THE INVENTION

In one embodiment of the present invention, a driver is used to filter read requests initiated by a client computer. If a file that is the subject of a read request is referenced by a local file system of the client computer, the driver routes the read request to the local file system. If a file that is the subject of a read request is not referenced by the local file system, the driver routes the read request to a remote file system. All requests to write files of the remote file system are routed to the local file system, thereby causing a file that is the subject of such a request to be written to the local file system.

Another embodiment of the present invention comprises a plurality of client computers, each of which maintains a local file system for accessing local files. A remote machine providing access to remote files is also provided. Each client computer is further provided with a driver to i) filter read requests initiated by the client computer, ii) route a read request to the local file system of the computer when a file that is the subject of the read request is maintained in the local files of its client computer, and otherwise route the read request to a remote file system for accessing the remote files, and iii) route to the local file system of the client computer, all requests to write the remote files.

Other embodiments of the invention are also disclosed.

### BRIEF DESCRIPTION OF THE DRAWINGS

Illustrative embodiments of the invention are illustrated in the drawings in which:

FIG. 1 illustrates exemplary apparatus for routing file access requests to local and remote file systems;

FIG. 2 is a flow diagram illustrating an exemplary method for routing file access requests that are filtered by the drivers shown in FIG. 1;

FIG. 3 is a flow diagram illustrating exemplary actions that may be taken by the method of FIG. 2 when determining where to route file read requests; and

FIG. 4 illustrates a computer-readable medium having sequences of instructions stored thereon that, when executed by a computer, cause the computer to perform the actions illustrated by the methods of FIGS. 2 & 3.

### DETAILED DESCRIPTION

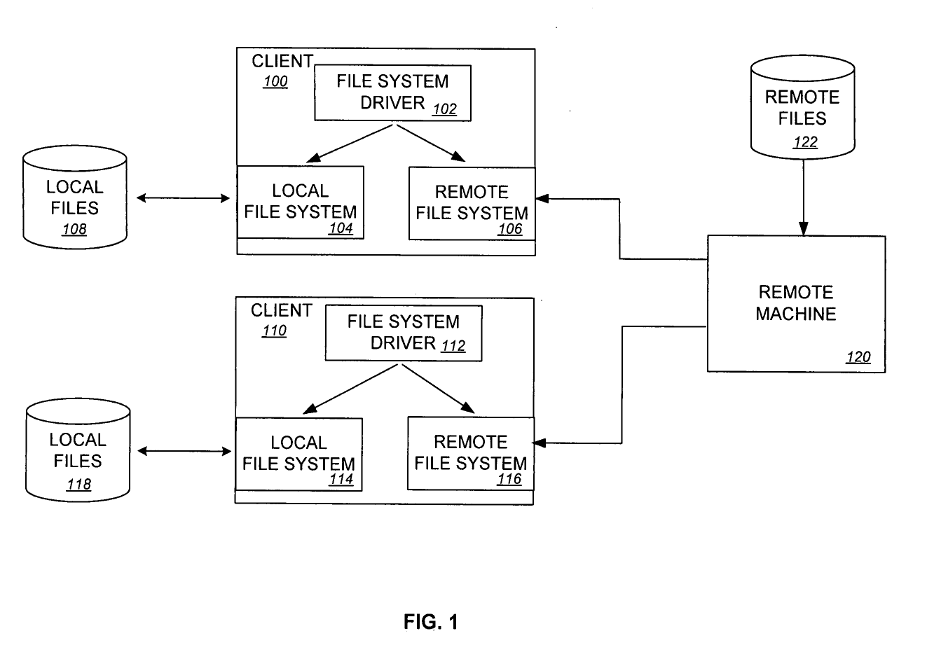

Exemplary apparatus for routing file access requests to remote and local file systems is shown in FIG. 1. By way of example, client computers 100, 110 are communicatively coupled to a remote machine 120. Clients 100, 110 may be servers, personal computers, or any other type of device that accesses files stored on (or accessed through) remote machine 120. Remote machine 120 may be a server, personal computer, storage device, or any other type of machine that serves to maintain or provide access to remote files 122. It should be appreciated that alternate embodiments of the apparatus shown in FIG. 1 may comprise different numbers and ratios of clients and remote machines.

Each client 100, 110 maintains a local file system 104, 114, and a remote file system 106, 116. Local file system 104 accesses local files 108. In a similar fashion, local file system 114 accesses local files 118. Local files 108, 118 may be files residing on a disk device or other type of storage device that may be part of the associated client 100, 110, or locally accessible to the associated client. The remote file systems 106, 116 are used to access remote files 122 associated with the remote machine 120. By way of example, the remote file system may be a UNIX file system such as Sun Microsystem Corporation's network file system (NFS) or Hewlett-Packard Company's distributed file system (DFS), or a LINUX file system.

Each client 100, 110 also has a file system driver 102, 112. In one embodiment, the file system drivers 102, 112 are embodied in software installed on the clients 100, 110. The file system drivers 102, 112 may be layered on top of existing file system drivers, and may utilize the inherent remote access and file management capabilities of the existing file system drivers. Thus, the file system drivers 102, 112 need not understand, nor intrude on, operating system kernels of the clients 100, 110. This may alleviate overhead and provide for faster access to files. Additionally, each file system driver 102, 112 may present a uniform view of the files referenced by its corresponding local file system 104, 114 and remote file system 106, 116. In this manner, the location of the file accessed is transparent to the user or application accessing the file.

As will be described in detail below, each file system driver 102, 112 may be used to filter file access requests and route them to the appropriate file system, either local or remote. In some embodiments, the filtered access requests are limited to read requests; and in other embodiments, the filtered access requests comprise both read and write requests. The filtered access requests can also be limited to requests to access certain types of files (e.g., operating system files or configuration files).

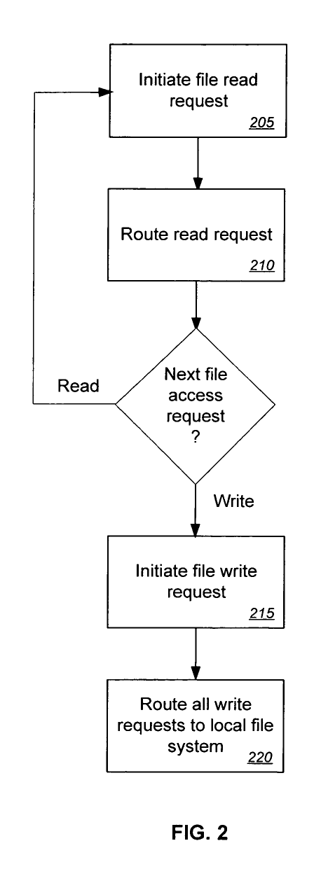

FIG. 2 illustrates a method that may be used by each file system driver 102, 112 to route file access requests. To begin, a request to read a file is initiated 205 by a client computer 100. As used herein, “reading” a file includes opening it, executing it, or otherwise retrieving or using its contents. By way of example, the file that is the subject of the read request could be an operating system file, a configuration file, or an application file.

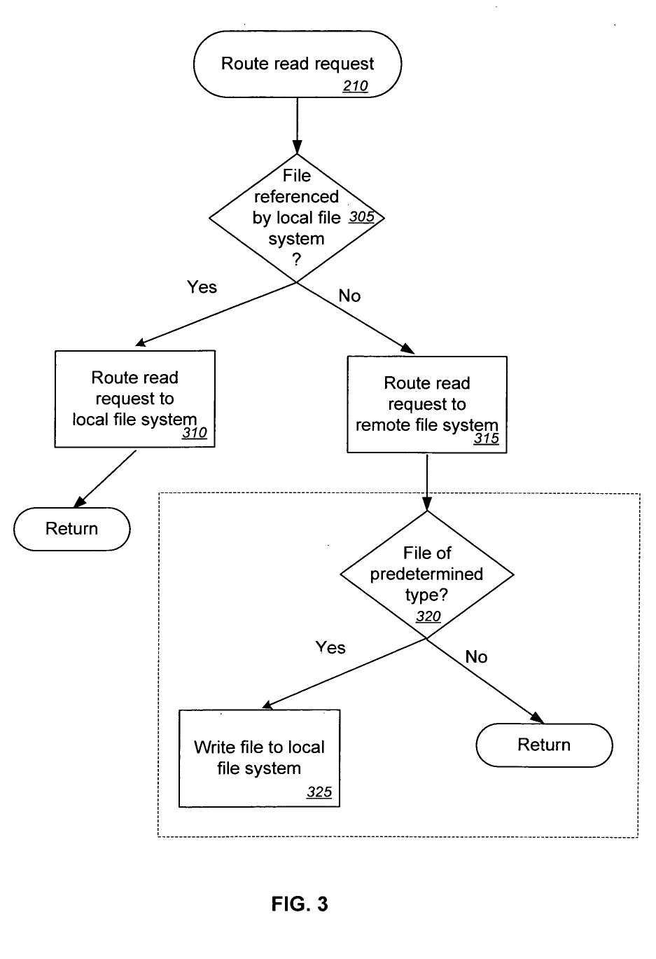

Next, the read request is routed 210 to either the local or remote file system. This process will be described in further detail with reference to FIG. 3. First, a determination is made as to whether the file that is the subject of the read request is referenced 305 by the local file system 104. If it is, the driver 102 routes 310 the read request to the local file system 104 and a return is made to the method of FIG. 2. Otherwise, the driver 102 routes 315 the read request to the remote file system 106.

Optionally, either before or after the file is accessed, a determination 320 may be made as to whether the file is of a predetermined type for which it would be desirable to write the file to the local file system 104. By way of example, the “predetermined type” may be operating system files, configuration files, and/or another type of file that might be better accessed via the local file system 104 for performance or other reasons. If it is determined that a file is of the predetermined type, the file is written 325 to the local file system 104, and all further requests to read the file are routed to the local file system 104 instead of the remote file system 106. Otherwise, a return may be made to the method of FIG. 2.

In one embodiment, the remote machine 120 may keep track of which files are of the predetermined type. In an alternate embodiment, the remote machine 120 may automatically write the files of a predetermined type to the local file system 104, regardless of whether the client 100 has attempted to access them (i.e., the files of a predetermined type may be “pushed” to the client 100). Pushed files, however, should be limited to files that are not subject to update within the local file system 104; or prior to pushing a file, steps may need to be taken to preserve any local modifications that have been made to a version of the file that is already being maintained by the local file system 104.

Returning to FIG. 2, after a file read request has been appropriately routed 210, a request to read the same or a different file may be initiated 205, or a write request may be initiated 215. If a write request is initiated 215, the write request is routed 220 to the local file system 104, thereby causing any file that previously only existed in the remote files 122 to be written to the local file system 104. After a file is written to the local file system 104, all subsequent requests to access the file are then also routed to the local file system (as illustrated by FIG. 3).

By routing all write requests to the local file system 104, the consistency of the remote files 122 may be preserved so that other clients 110 may access a “clean” or “master” image of the remote files 122. If a client needs to modify or write one of the remote files 122, the client writes the modified file to its local file system 104. By way of example, clients may store operating system configuration files or other types of configuration files locally. Future access requests for these locally-stored files are then directed to the client's local file system. Other clients that have not written the files locally still access the master files on the remote machine. Thus, files on the remote machine are kept in a consistent state, but each client is still able to modify the files to meet its individual needs.

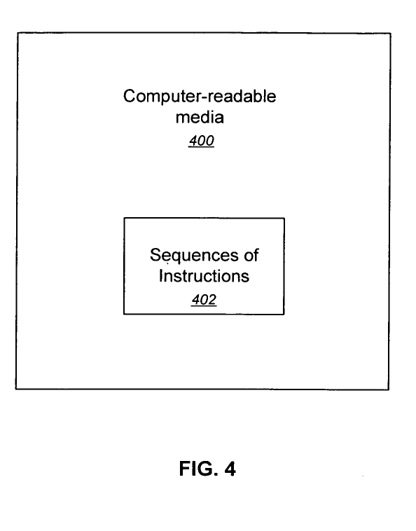

It should be appreciated that the methods described herein may be implemented by sequences of instructions 400 stored on one or more computer-readable mediums 402. See FIG. 4. When executed by a computer 100, the sequences of instructions 400 may cause the computer 100 to perform the actions of the methods depicted in FIGS. 2 & 3. By way of example, the computer-readable mediums may comprise CD-ROMs or other type of optical disks, floppy diskettes, ROMs, RAMs, EPROMs, EEPROMs, magnetic or optical cards, flash memory, hard drives or other types of computer-readable mediums that are suited to storing computer-executable instructions.

1. A method, comprising:
using a driver to filter read requests initiated by a client computer, wherein if a file that is the subject of a read request is referenced by a local file system of the client computer, the driver routes the read request to the local file system, and if a file that is the subject of a read request is not referenced by the local file system, the driver routes the read request to a remote file system;
routing to the local file system all requests to write files of the remote file system, thereby causing a file that is the subject of such a request to be written to the local file system.

2. The method of claim 1, wherein said files that are the subject of said read and write requests comprise operating system files.

3. The method of claim 1, further comprising, if a read request is routed to the remote file system, and if the file to be read is of a predetermined type, then automatically causing the file to be written from the remote file system to the local file system.

4. The method of claim 3, wherein said predetermined type of files comprises configuration files.

5. The method of claim 1, wherein the remote file system comprises a UNIX file system.

6. The method of claim 1, further comprising, presenting a user of the client computer a uniform view of the files of the local and remote file systems.

7. The method of claim 1, further comprising, filtering said write requests via said driver.

8. A method, comprising:
receiving a client computer's request to read a file;
by means of a driver of the client computer, routing the read request to a remote file system; and
upon receiving the client computer's request to write to the file, writing the file to a local file system of the client computer.

9. The method of claim 8, further comprising, prior to routing the read request to the remote file system, determining the file to be read is not referenced by the local file system.

10. The method of claim 8, further comprising, after writing the file to the local file system, routing all further requests to read the file to the local file system.

11. One or more computer-readable mediums having stored thereon sequences of instructions that, when executed by a computer, cause the computer to perform the actions:
use a driver to filter read requests initiated by a client computer, wherein if a file that is the subject of a read request is referenced by a local file system of the client computer, the driver routes the read request to the local file system, and if a file that is the subject of a read request is not referenced by the local file system, the driver routes the read request to a remote file system;
route to the local file system all requests to write files of the remote file system, thereby causing a file that is the subject of such a request to be written to the local file system.

12. The medium of claim 11, wherein said read requests filtered by said driver comprise requests to read operating system files.

13. The medium of claim 11, wherein said read requests filtered by said driver comprise requests to read configuration files.

14. The medium of claim 11, further comprising instructions that, when executed by the computer, cause the computer to perform the actions:
if the file does not exist on the local file system and the file comprises a predetermined type, writing the file to the local file system.

15. The medium of claim 14, wherein said predetermined type of files comprises operating system files.

16. The medium of claim 14, wherein said predetermined type of files comprises configuration files.

17. The medium of claim 11, wherein the remote file system comprises a UNIX distributed file system.

18. The medium of claim 11, wherein the remote file system comprises a UNIX network file system.

19. The medium of claim 11, wherein said driver also filters said write requests.

20. A system, comprising:
a plurality of client computers, each of which maintains a local file system for accessing local files;
a remote machine providing access to remote files; and
on each client computer, a driver to i) filter read requests initiated by the client computer, ii) route a read request to the local file system of the client computer when a file that is the subject of the read request is maintained in the local files of the client computer, and otherwise route the read request to a remote file system for accessing the remote files, and iii) route to the local file system of the client computer, all requests to write the remote files.
